(19) United States
(12) Patent Application Publication
(10) Pub. No.: US 2024/0192476 A1
(43) Pub. Date: Jun. 13, 2024

(54) SIGNAL TRANSMITTING/RECEIVING DEVICE

(71) Applicant: Panasonic Intellectual Property Management Co., Ltd., Osaka (JP)

(72) Inventor: Hiroyuki FURUYA, Osaka (JP)

(21) Appl. No.: 18/419,437

(22) Filed: Jan. 22, 2024

Related U.S. Application Data
(63) Continuation of application No. PCT/JP2022/017162, filed on Apr. 6, 2022.

(30) Foreign Application Priority Data
Jul. 27, 2021 (JP) 2021-122155

(51) Int. Cl. G02B 19/00; G02B 27/28

(52) U.S. Cl. CPC G02B 19/0019; G02B 19/0076; G02B 27/283

(57) ABSTRACT

A signal transmitting/receiving device includes: a light source part configured to emit transmission light; a light-receiving part having a photodetector configured to receive reception light; and a condenser mirror configured to condense the reception light on the photodetector. The condenser mirror has a through hole configured to allow the transmission light emitted from the light source part to pass therethrough and align an optical axis of the light source part and an optical axis of the condenser mirror with each other. A reflection surface of the condenser mirror has a shape obtained by cutting out a columnar body extending in an emission direction of the transmission light, with a spheroid whose rotation axis is a major axis.

### CROSS REFERENCE TO RELATED APPLICATION

This application is a continuation of International Application No. PCT/JP2022/017162 filed on Apr. 6, 2022, entitled “SIGNAL TRANSMITTING/RECEIVING DEVICE”, which claims priority under 35 U.S.C. Section 119 of Japanese Patent Application No. 2021-122155 filed on Jul. 27, 2021, entitled “SIGNAL TRANSMITTING/RECEIVING DEVICE”. The disclosures of the above applications are incorporated herein by reference.

### BACKGROUND OF THE INVENTION

### Field of the Invention

The present invention relates to a signal transmitting/receiving device for transmitting and receiving signals using light.

### Description of Related Art

To date, a signal transmitting/receiving device for transmitting and receiving signals using light has been known. For example, Japanese Laid-Open Patent Publication No. 2017-220738 describes an optical communication system including: an optical transmitter having a plurality of light-emitting elements; and an optical receiver having a plurality of light-receiving elements. In this system, light emitted from each light-emitting element of the optical transmitter is collimated by an optical member and received by the corresponding light-receiving element of the optical receiver side.

In the configuration of Japanese Laid-Open Patent Publication No. 2017-220738, the light emitted from each light-emitting element is collimated by the optical member, but usually does not become perfectly collimated and becomes slightly diffused. For example, during transmission, a light beam having a diameter of 3 mm and a spread angle of 0.3 mrad becomes a beam having a diameter of about 5 cm at a distance of 200 m away. Therefore, if the distance between the transmitter and the receiver is long, the light transmitted from the optical transmitter side spreads greatly on the optical receiver side, and each light-receiving element of the optical receiver side cannot receive light having sufficient intensity in some cases. In addition, if optical axis misalignment occurs between the light-emitting element and the light-receiving element, or if one optical axis is tilted with respect to the other optical axis, the light transmitted from the optical transmitter side cannot be guided with sufficient intensity to each light-receiving element of the optical receiver side in some cases.

### SUMMARY OF THE INVENTION

A signal transmitting/receiving device according to a main aspect of the present invention includes: a light source part configured to emit transmission light; a light-receiving part having a photodetector configured to receive reception light; and a condenser mirror configured to condense the reception light on the photodetector. The condenser mirror has a through hole configured to allow the transmission light emitted from the light source part to pass therethrough and align an optical axis of the light source part and an optical axis of the condenser mirror with each other. A reflection surface of the condenser mirror has a shape obtained by cutting out a columnar body extending in an emission direction of the transmission light, with a spheroid whose rotation axis is a major axis.

In the signal transmitting/receiving device according to this aspect, the optical axis of the light source part and the optical axis of the condenser mirror are aligned with each other, so that position adjustment can be performed simply and smoothly with respect to another signal transmitting/receiving device. In addition, since the reflection surface of the condenser mirror has a shape obtained by cutting the columnar body extending in the emission direction of the transmission light, with the spheroid whose rotation axis is the major axis, even if slight optical axis misalignment or optical axis tilt occurs with respect to the other signal transmitting/receiving device, reception light from the other signal transmitting/receiving device can be guided with sufficient intensity to the photodetector of the signal transmitting/receiving device.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1 is a perspective view showing an external configuration of a condenser mirror according to Embodiment 1;

FIG. 2A and FIG. 2B are respectively a back view and a back perspective view of the condenser mirror according to Embodiment 1;

FIG. 3 is a side view showing a configuration of a signal transmitting/receiving device according to Embodiment 1;

FIG. 4 is a side view showing a configuration of a signal transmitting/receiving system according to Embodiment 1;

FIG. 5 is a block diagram showing a configuration of a circuitry of the signal transmitting/receiving device according to Embodiment 1;

FIG. 6 illustrates a method for forming a reflection surface according to Embodiment 1;

FIG. 7A and FIG. 7B each show a reception state of reception light when optical axis misalignment or optical axis tilt occurs between a pair of signal transmitting/receiving devices included in the signal transmitting/receiving system according to Embodiment 1;

FIG. 8 is a perspective view showing a configuration of a mirror unit according to Embodiment 2;

FIG. 9 is a partial side view showing a configuration of a signal transmitting/receiving device according to Embodiment 2;

FIG. 10 is a block diagram showing a configuration of a circuitry of the signal transmitting/receiving device according to Embodiment 2;

FIG. 11 shows the phases of transmission light set for transmitting/receiving units of one signal transmitting/receiving device in an adjustment mode according to Embodiment 2;

FIG. 12A to FIG. 12C each schematically show the intensity change of transmission light transmitted toward another signal transmitting/receiving device when the adjustment mode is executed according to Embodiment 2;

FIG. 12D and FIG. 12E each schematically show the intensity change of a detection signal outputted from a photodetector of a transmitting/receiving unit at the center of the other signal transmitting/receiving device when the adjustment mode is executed according to Embodiment 2;

FIG. 13 is a side view showing a configuration of a sensor device according to a reference example;

FIG. 14 is a side view showing another configuration of the sensor device according to the reference example; and

FIG. 15 is a side view showing still another configuration of the sensor device according to the reference example.

It should be noted that the drawings are solely for description and do not limit the scope of the present invention by any degree.

### DETAILED DESCRIPTION

The following embodiments each show an example of a configuration in which the present invention is applied to a signal transmitting/receiving device for use in a signal transmitting/receiving system. The signal transmitting/receiving system includes a pair of signal transmitting/receiving devices. The pair of signal transmitting/receiving devices have the same configuration. Transmission light transmitted from one signal transmitting/receiving device is received by the other signal transmitting/receiving device as reception light. In addition, transmission light transmitted from the other signal transmitting/receiving device is received by the one signal transmitting/receiving device as reception light. Each transmission light is modulated in accordance with transmission data. The signal transmitting/receiving device on the receiving side demodulates the modulated transmission light to generate reception data.

In the following embodiments, the configuration of one signal transmitting/receiving device will be mainly described. The other signal transmitting/receiving device has the same configuration as the one signal transmitting/receiving device. However, the other signal transmitting/receiving device does not necessarily have to have the same configuration as the one signal transmitting/receiving device, and the configuration of the other signal transmitting/receiving device may be different from the configuration of the one signal transmitting/receiving device as long as the other signal transmitting/receiving device can properly transmit and receive signals.

### Embodiment 1

Hereinafter, Embodiment 1 of the present invention will be described with reference to the drawings. For convenience, in each drawing, X, Y, and Z axes that are orthogonal to each other are additionally shown as appropriate. The Z-axis positive direction is an emission direction of transmission light, and the X-axis direction and the Y-axis direction are the width direction and the height direction of a signal transmitting/receiving device 1, respectively.

### Structure of Condenser Mirror

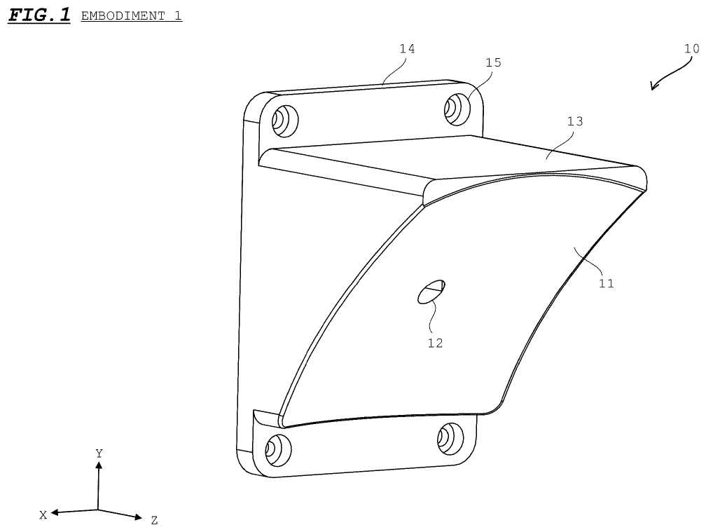

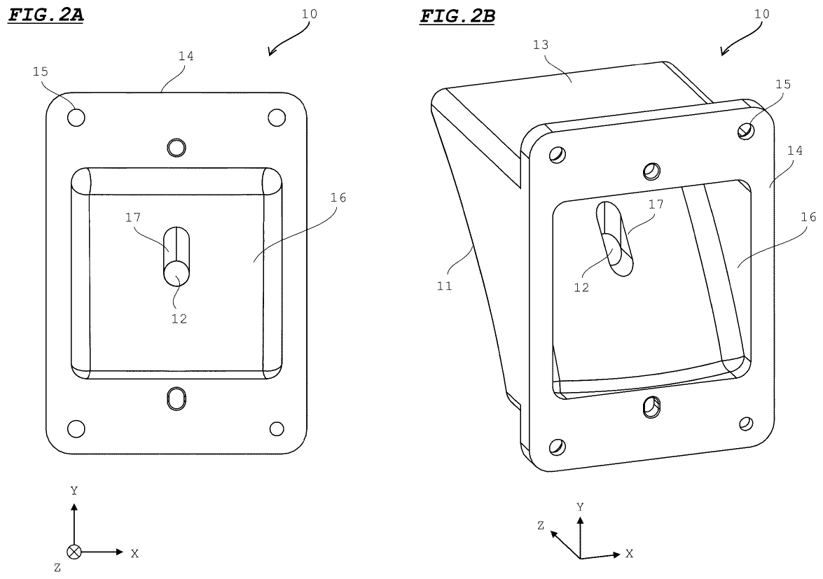

FIG. 1 is a perspective view showing an external configuration of a condenser mirror 10 installed in the signal transmitting/receiving device 1. FIG. 2A is a back view of the condenser mirror 10, and FIG. 2B is a perspective view of the condenser mirror 10 as viewed from the back side.

The condenser mirror 10 has a reflection surface 11, a through hole 12, a columnar portion 13, a back plate portion 14, fastening holes 15, an opening 16, and a cutout 17. The condenser mirror 10 is integrally formed from a metal material such as aluminum. The condenser mirror 10 may be formed from a resin material.

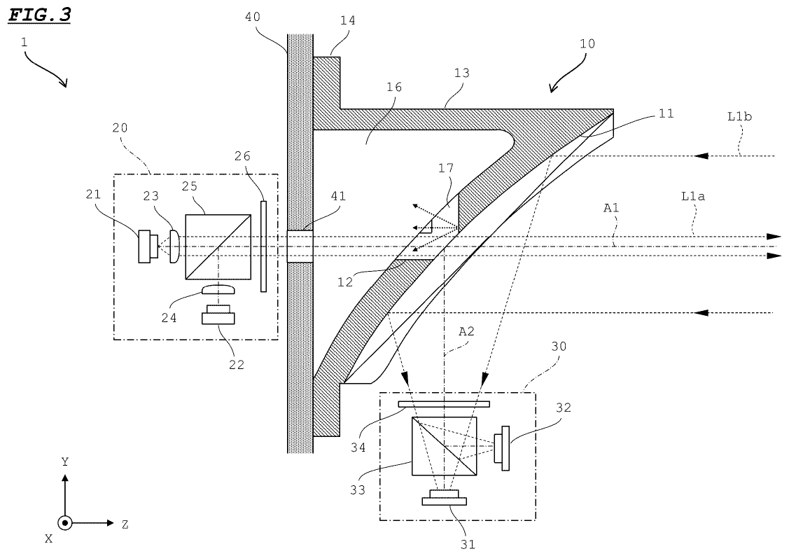

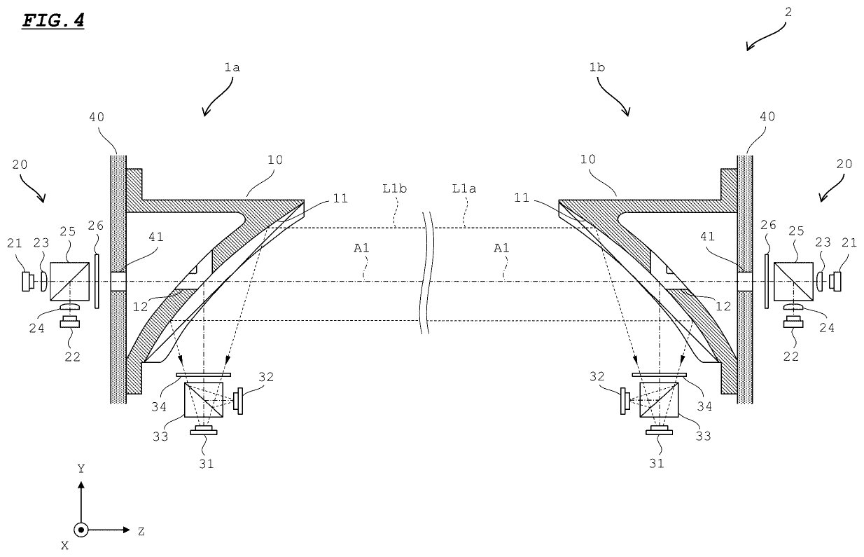

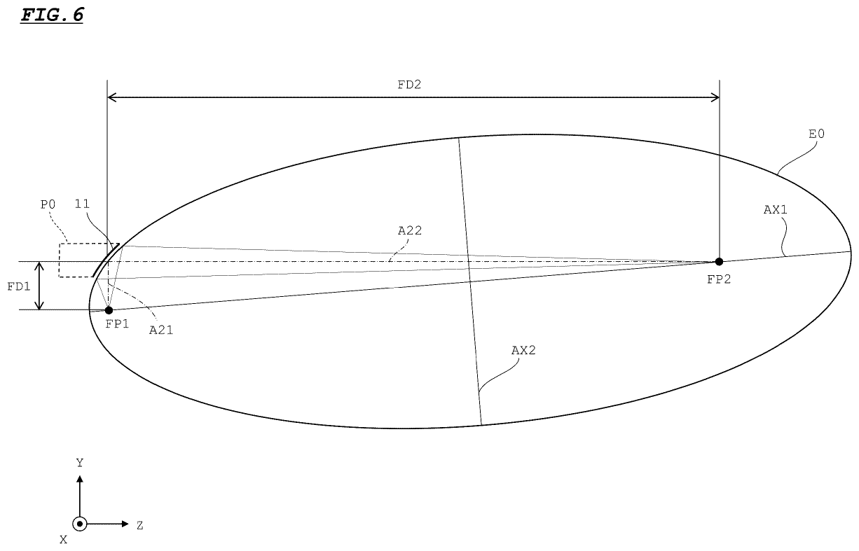

The reflection surface 11 reflects reception light L1b (see FIG. 4) incident in the Z-axis negative direction thereon, in the Y-axis negative direction, and condenses the reception light L1b. The reflection surface 11 is a curved surface recessed inward of the condenser mirror 10. The reflection surface 11 is formed by performing mirror finish on an inwardly recessed curved surface and then depositing a high-reflectance material such as gold on the curved surface. The shape of the reflection surface 11 is a shape obtained by cutting out a columnar body having a quadrangular prism shape extending in an emission direction of transmission light L1a (see FIG. 3) described later (in the present embodiment, for example, having a width in the X-axis direction of 5 cm, a width in the Y-axis direction of 5 cm, and a width in the Z-axis direction of 5 cm) with a spheroid whose rotation axis is a major axis parallel to the emission direction. A method for setting the shape of the reflection surface 11 will be described later with reference to FIG. 6.

The through hole 12 penetrates the condenser mirror 10 in the Z-axis direction. The through hole 12 is for allowing the transmission light L1a emitted from a light source part 20 (see FIG. 3) described later to pass therethrough. The through hole 12 is formed along the central axis of the columnar portion 13. The transmission light L1a passes through the through hole 12 and is emitted in the Z-axis positive direction.

The columnar portion 13 has a square shape with rounded corners when viewed from the Z-axis positive side. The columnar portion 13 has a shape obtained by cutting out a columnar body extending in the Z-axis direction, along the reflection surface 11. As shown in FIG. 2A and FIG. 2B, the opening 16 having a square shape with rounded corners in a back view is formed in the back surface of the columnar portion 13. The above-described through hole 12 is formed in an inner surface on the Z-axis positive side of the opening 16, and the cutout 17 is further formed at the exit of the through hole 12 so as to extend in the Y-axis positive direction.

The back plate portion 14 is for installing the condenser mirror 10 on a support member 40 (see FIG. 3) described later. As shown in FIG. 2A, the back plate portion 14 has a rectangular shape with rounded corners in a plan view. The thickness of the back plate portion 14 is constant. At each of the four corners of the back plate portion 14, the fastening hole 15 is formed so as to penetrate the back plate portion 14 in the Z-axis direction. The condenser mirror 10 is installed on the support member 40 by fastening screws to the support member 40 described later through the fastening holes 15.

### Configuration of Signal Transmitting/Receiving Device

FIG. 3 is a side view showing a configuration of the signal transmitting/receiving device 1. For convenience, in FIG. 3, the condenser mirror 10 and the support member 40 are shown in a cross-sectional view taken along a plane parallel to the Y-Z plane at the middle position in the X-axis direction of the condenser mirror 10.

As shown in FIG. 3, the signal transmitting/receiving device 1 includes the light source part 20, a light-receiving part 30, and the support member 40 in addition to the condenser mirror 10 described above.

The light source part 20 includes light sources 21 and 22, collimator lenses 23 and 24, a combining element 25, and a wave plate 26.

The light sources 21 and 22 are, for example, semiconductor lasers that emit laser light. The emission wavelengths of the light sources 21 and 22 are, for example, infrared wavelengths (about 800 nm). A light source having a wavelength in the 900 nm band may be used to reduce the influence of external light such as sunlight, or a light source having a wavelength in the 1.3 μm band or 1.5 μm band may be used to prevent interference with other communication devices. The emission wavelengths of the light sources 21 and 22 may be wavelengths other than infrared wavelengths, such as visible light wavelengths.

The light source 21 is placed such that the emission optical axis thereof is parallel to the Z axis, and the light source 22 is placed such that the emission optical axis thereof is parallel to the Y axis. The emission optical axis of the light source 21 and the emission optical axis of the light source 22 are orthogonal to each other. The light source 21 emits light in the Z-axis positive direction, and the light source 22 emits light in the Y-axis positive direction. Each of the laser lights emitted from the light sources 21 and 22 is modulated by transmission data. Accordingly, the transmission light L1a is generated.

The collimator lenses 23 and 24 collimate the laser lights emitted from the light sources 21 and 22, respectively. The lights passing through the collimator lenses 23 and 24 strictly do not become perfectly collimated but each become light that slightly spreads from collimated light.

The combining element 25 aligns the optical axes of the transmission lights L1a emitted from the light sources 21 and 22, respectively. The combining element 25 is placed at a position at which the emission optical axes of the light sources 21 and 22 are orthogonal to each other. The combining element 25 is, for example, a polarization beam splitter. In this case, the light source 21 is placed such that the linearly polarized laser light emitted from the light source 21 is P-polarized with respect to the combining element 25. In addition, the light source 22 is placed such that the linearly polarized laser light emitted from the light source 22 is S-polarized with respect to the combining element 25. Accordingly, the optical axes of the transmission lights L1a passing through the combining element 25 from the light sources 21 and 22 are aligned with each other. An optical axis A1 after alignment is parallel to the Z axis.

The wave plate 26 converts each of the linearly polarized lights emitted from the light sources 21 and 22, into circularly polarized light. The wave plate 26 is a quarter-wave plate. The wave plate 26 is placed at the stage subsequent to the combining element 25. The wave plate 26 converts each of the transmission lights L1a, from the light sources 21 and 22, whose optical axes are aligned by the combining element 25, into circularly polarized light.

The light-receiving part 30 includes photodetectors 31 and 32, a splitting element 33, and a wave plate 34.

The photodetectors 31 and 32 receive the reception light L1b condensed by the reflection surface 11 of the condenser mirror 10. The reception light L1b is transmission light emitted from another signal transmitting/receiving device 1. For example, PIN photodiodes can be used as the photodetectors 31 and 32. Furthermore, the detection sensitivity of the photodetectors 31 and 32 can be enhanced by using avalanche photodiodes.

The splitting element 33 splits the two types of reception light L1b condensed by the condenser mirror 10, and guides the two types of reception light L1b to the photodetectors 31 and 32, respectively. The splitting element 33 is, for example, a polarization beam splitter. In this case, out of the two types of reception light L1b, the splitting element 33 reflects the reception light L1b incident as S-polarized light, and guides the reception light L1b to the photodetector 32, and the splitting element 33 transmits the reception light L1b incident as P-polarized light and guides the reception light L1b to the photodetector 31.

The wave plate 34 converts the reception light L1b incident as circularly polarized light, into linearly polarized light. The wave plate 34 is a quarter-wave plate. The wave plate 34 is placed at the stage previous to the splitting element 33. Out of the two types of circularly polarized reception light L1b whose rotation directions are opposite to each other, one reception light L1b is converted by the wave plate 34 into linearly polarized light that is P-polarized with respect to the splitting element 33, and the other reception light L1b is converted by the wave plate 34 into linearly polarized light that is S-polarized with respect to the splitting element 33. Accordingly, these two types of reception light L1b are split by the splitting element 33 and received by the photodetectors 31 and 32, respectively, as described above.

The support member 40 is a plate-shaped member having a predetermined thickness. The support member 40 is made of a metal material having high rigidity. A circular passage hole 41 is formed in the support member 40. In a state where the condenser mirror 10 is installed on the support member 40, the passage hole 41 is coaxial with the through hole 12 of the condenser mirror 10. The central axes of the through hole 12 and the passage hole 41 are parallel to the Z axis.

The light source part 20 is installed on the back side of the support member 40. The emission optical axes of the respective light sources 21 and 22 aligned by the combining element 25, that is, the optical axis A1 of the light source part 20, coincides with the central axes of the through hole 12 and the passage hole 41. Accordingly, the transmission light L1a emitted from the light source part 20 is emitted in the Z-axis direction through the passage hole 41 and the through hole 12.

The light-receiving part 30 is placed below the condenser mirror 10. The light-receiving part 30 is placed such that an optical axis A2 of the reflection surface 11 of the condenser mirror 10 is aligned with the center of a light-receiving surface of the photodetector 31. The optical axis A2 bent by the splitting element 33 is aligned with the center of a light-receiving surface of the photodetector 32. Accordingly, the two types of reception light L1b reflected and condensed by the reflection surface 11 are received by the photodetectors 31 and 32, respectively.

The optical axis A2 of the reflection surface 11 is bent by 90 degrees in a direction parallel to the Y-Z plane, through the reflection surface 11. The optical axis A2, at the reflection surface 11, parallel to the Z axis is aligned with the optical axis A1 of the light source part 20. That is, the through hole 12 allows the transmission light L1a emitted from the light source part 20 to pass therethrough, and aligns the optical axis A1 of the light source part 20 and the optical axis A2 of the condenser mirror 10 with each other.

As described above, the cutout 17 is formed at the exit of the through hole 12 so as to extend in the Y-axis positive direction. That is, at the through hole 12, the cutout 17 is formed in an inner surface facing the light-receiving part 30. Therefore, even if a part of the transmission light L1a emitted from the light source part 20 reaches the exit of the through hole 12 and is scattered, the scattered transmission light L1a travels in a direction toward the interior of the opening 16. The scattered transmission light L1a incident on the opening 16 is attenuated as being repeatedly reflected by an inner surface of a space surrounded by the opening 16 and the support member 40. A light absorber may be applied to the inner surface of the space surrounded by the opening 16 and the support member 40.

### Signal Transmitting/Receiving System

FIG. 4 is a side view showing a configuration of a signal transmitting/receiving system 2. As in FIG. 3, in FIG. 4, each condenser mirror 10 and each support member 40 are shown in a cross-sectional view taken along a plane parallel to the Y-Z plane at the middle position in the X-axis direction of the condenser mirror 10.

As shown in FIG. 4, the signal transmitting/receiving system 2 includes a pair of signal transmitting/receiving devices 1a and 1b. The configurations of the signal transmitting/receiving devices 1a and 1b are both the same as that of the signal transmitting/receiving device 1 shown in FIG. 3. For convenience, to distinguish the two signal transmitting/receiving devices 1, each signal transmitting/receiving device is designated by reference character 1a or 1b. The signal transmitting/receiving device 1a corresponds to the signal transmitting/receiving device 1 shown in FIG. 3.

In FIG. 4, transmission light emitted from the signal transmitting/receiving device 1a is designated by L1a, and transmission light emitted from the signal transmitting/receiving device 1b on the right side is designated by L1b. The transmission light L1b emitted from the signal transmitting/receiving device 1b on the right side is reception light received by the signal transmitting/receiving device 1a on the left side. Therefore, in the configuration in FIG. 3, the reception light is designated by L1b.

The two signal transmitting/receiving devices 1a and 1b are placed facing each other such that the optical axes A1 thereof coincide with each other. The two signal transmitting/receiving devices 1a and 1b are placed so as to be spaced apart from each other by a predetermined distance, and transmit and receive data using the transmission lights L1a and L1b. As described above, the transmission lights L1a and L1b are modulated by transmission data. For example, the transmission lights L1a and L1b are AM-modulated by transmission data. For example, a PAM4 (Pulse Amplitude Modulation 4) modulation method is used as the AM modulation method. The transmission lights L1b emitted from the light sources 21 and 22 are individually modulated by the respective transmission data.

The transmission lights L1a emitted from the light sources 21 and 22 are collimated by the collimator lenses 23 and 24. However, as described above, the transmission lights L1a are not converted by the collimator lenses 23 and 24 into perfectly collimated lights, and each become light that slightly spreads from collimated light. Therefore, when the transmission light L1a emitted from the signal transmitting/receiving device 1a on the left side reaches the signal transmitting/receiving device 1b on the right side, the transmission light L1a has a beam size in which the transmission light L1a spreads in the in-plane direction of the X-Y plane as shown in FIG. 4. Similarly, when the transmission light L1b emitted from the signal transmitting/receiving device 1b on the right side reaches the signal transmitting/receiving device 1a on the left side, the transmission light L1b has a beam size in which the transmission light L1b spreads in the in-plane direction of the X-Y plane.

The transmission light L1a emitted from the signal transmitting/receiving device 1a is reflected and condensed by the condenser mirror 10 of the signal transmitting/receiving device 1b and received by the photodetectors 31 and 32 of the signal transmitting/receiving device 1b.

The transmission light L1a emitted from the light source 21 of the signal transmitting/receiving device 1a is received by the photodetector 31 of the signal transmitting/receiving device 1b, and the transmission light L1a emitted from the light source 22 of the signal transmitting/receiving device 1a is received by the photodetector 32 of the signal transmitting/receiving device 1b. Accordingly, detection signals corresponding to the transmission data are outputted from the photodetectors 31 and 32.

The transmission light L1b emitted from the signal transmitting/receiving device 1b is reflected and condensed by the condenser mirror 10 of the signal transmitting/receiving device 1a and received by the photodetectors 31 and 32 of the signal transmitting/receiving device 1a. Accordingly, detection signals corresponding to the transmission data are outputted from the photodetectors 31 and 32. Each detection signal is demodulated to generate reception data. In this manner, data communication is performed between the signal transmitting/receiving devices 1a and 1b.

### Configuration of Circuitry

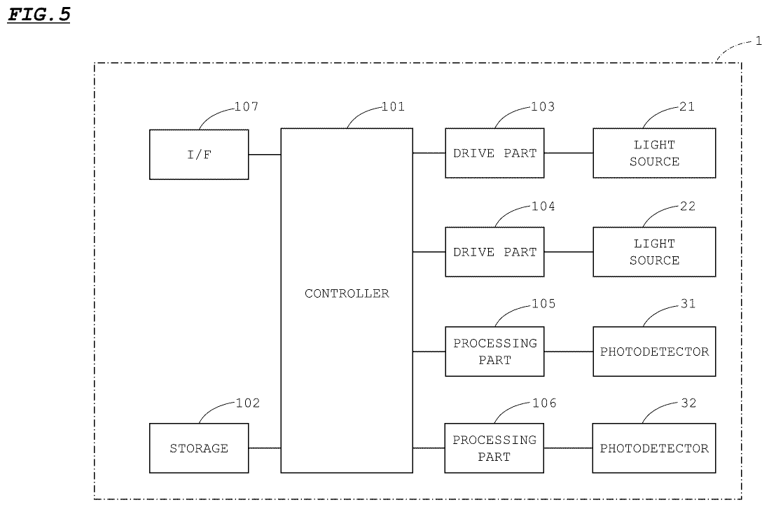

FIG. 5 is a block diagram showing a configuration of a circuitry of the signal transmitting/receiving device 1.

The signal transmitting/receiving device 1 includes a controller 101, a storage 102, drive parts 103 and 104, processing parts 105 and 106, and an interface 107 in addition to the light sources 21 and 22 and the photodetectors 31 and 32 shown in FIG. 3.

The controller 101 is implemented by a CPU or a microcomputer, for example. The controller 101 controls components in the signal transmitting/receiving device 1 in accordance with a control program stored in the storage 102. The storage 102 includes a memory, stores the control program, and is used as a work region during control processing.

The drive parts 103 and 104 drive the light sources 21 and 22, respectively, in accordance with control from the controller 101. The processing parts 105 and 106 perform amplification and noise removal on the detection signals inputted from the photodetectors 31 and 32, convert the processed detection signals into digital signals, and output the digital signals to the controller 101. The interface 107 performs data communication with a higher-order system.

In the signal transmitting/receiving system 2 shown in FIG. 4, when communication is performed with the other signal transmitting/receiving device 1b, the controller 101 generates AM-modulated transmission signals on the basis of transmission data of two channels inputted from the higher-order system via the interface 107, and outputs the generated transmission signals of the two channels to the drive parts 103 and 104, respectively. The drive parts 103 and 104 modulate the emission power of the light sources 21 and 22, respectively, by the transmission signals inputted from the controller 101. Accordingly, the transmission lights L1a optically modulated by the transmission data of the respective channels are emitted from the light sources 21 and 22, respectively. The emitted transmission lights L1a are received by the other signal transmitting/receiving device 1b.

The transmission lights L1b of two channels transmitted from the other signal transmitting/receiving device 1b are received by the photodetectors 31 and 32, respectively, and detection signals are outputted from the photodetectors 31 and 32, respectively. The detection signal of each channel is processed by the processing part 105 and outputted to the controller 101. The controller 101 demodulates the inputted detection signal of each channel to generate reception data. The controller 101 transmits the generated reception data to the higher-order system via the interface 107.

Similarly, the above processing is also performed in the other signal transmitting/receiving device 1b. Accordingly, data communication is performed by the two signal transmitting/receiving devices 1 using the transmission light L1a.

### Method for Forming Reflection Surface

FIG. 6 illustrates a method for forming the reflection surface 11.

As shown in FIG. 6, in the case where one ridge of the reflection surface 11 has a shape along a part of a predetermined ellipse E0, light emitted from a first focal position FP1 on a major axis AX1 of the ellipse E0 is condensed to a second focal position FP2 on the major axis AX1 by the reflection surface 11. Conversely, light emitted from the second focal position FP2 is condensed to the first focal position FP1 on the major axis AX1 by the reflection surface 11.

Here, an optical axis A21 extending from the reflection surface 11 toward the first focal position FP1 and an optical axis A22 extending from the reflection surface 11 toward the second focal position FP2 are perpendicular to each other. In addition, a first focal distance FD1 to the first focal position FP1 and a second focal distance FD2 to the second focal position FP2 change according to the ratio of the major axis AX1 to a minor axis AX2 of the ellipse E0. In other words, the ratio of the major axis AX1 to the minor axis AX2 changes according to the lengths of the first focal distance FD1 and the second focal distance FD2, and the shape of the ellipse E0 also changes. Accordingly, the shape of the ridge of the reflection surface 11 also changes.

In the present embodiment, the light source part 20 of the other signal transmitting/receiving device 1b is installed in the direction from the reflection surface 11 toward the second focal position FP2, and the light-receiving part 30 of the one signal transmitting/receiving device 1a is placed in the direction from the reflection surface 11 toward the first focal position FP1. The first focal distance FD1 is set to around the distance between the reflection surface 11 and the photodetector 32 in the signal transmitting/receiving device 1a, and the second focal distance FD2 is set to around the distance between the reflection surface 11 and the light source part 20 of the other signal transmitting/receiving device 1b.

In the present embodiment, the shape of the reflection surface 11 is set to a cross-sectional shape obtained by cutting out a columnar body P0, which is a quadrangular prism extending in a direction along the optical axis A22, with a spheroid whose rotation axis is the major axis AX1 including the first focal position FP1 and the second focal position FP2. Two opposing side surfaces of the columnar body P0 (quadrangular prism) are parallel to a plane including the optical axes A21 and A22, and the other two opposing side surfaces of the columnar body P0 (quadrangular prism) are perpendicular to the plane including the optical axes A21 and A22. The central axis of the columnar body P0 (quadrangular prism) coincides with the optical axis A22 extending toward the second focal position FP2. The optical axis A21 and the optical axis A22 in FIG. 6 correspond to the optical axis A2 and the optical axis A1 in FIG. 3, respectively.

By setting the shape of the reflection surface 11 as described above, the reception light L1b from the light source part 20 of the other signal transmitting/receiving device 1b which is placed near the second focal position FP2 can be efficiently condensed on the light-receiving surface of the photodetector 31, which is placed near the first focal position FP1, and the light-receiving surface of the photodetector 32, which is placed at the same position of the optical path length as the optical axis A21. That is, a greater amount of the reception light L1b can be condensed on each of the photodetectors 31 and 32 than in the case where the reflection surface 11 is set to a parabolic surface that condenses collimated light from infinity, on the light-receiving surfaces of the photodetectors 31 and 32.

The other signal transmitting/receiving device 1b is placed such that the light source part 20 thereof is positioned near the second focal position FP2 as described above. The shape of the reflection surface 11 of the other signal transmitting/receiving device 1b is also set in the same manner as above. The other signal transmitting/receiving device 1b is also placed facing the one signal transmitting/receiving device 1a such that the optical axis A1 of the other signal transmitting/receiving device 1b coincides with the optical axis A1 of the one signal transmitting/receiving device 1a. Accordingly, the positional relationship between the reflection surface 11 of the other signal transmitting/receiving device 1b and the light source part 20 of the one signal transmitting/receiving device 1a is also the same as the positional relationship between the reflection surface 11 and the second focal position FP2 shown in FIG. 6. Therefore, the other signal transmitting/receiving device 1b can also efficiently receive the transmission light L1a from the one signal transmitting/receiving device 1a.

By setting the shapes of the reflection surfaces 11 of the signal transmitting/receiving devices 1a and 1b as described above, even if slight misalignment occurs between the optical axes A1 of the signal transmitting/receiving devices 1a and 1b, or even if one of the optical axes A1 of the signal transmitting/receiving devices 1a and 1b is slightly tilted with respect to the other optical axis A1, the transmission light L1a emitted from one of the signal transmitting/receiving devices 1a and 1b can be efficiently received by the photodetectors 31 and 32 of the other of the signal transmitting/receiving devices 1a and 1b.

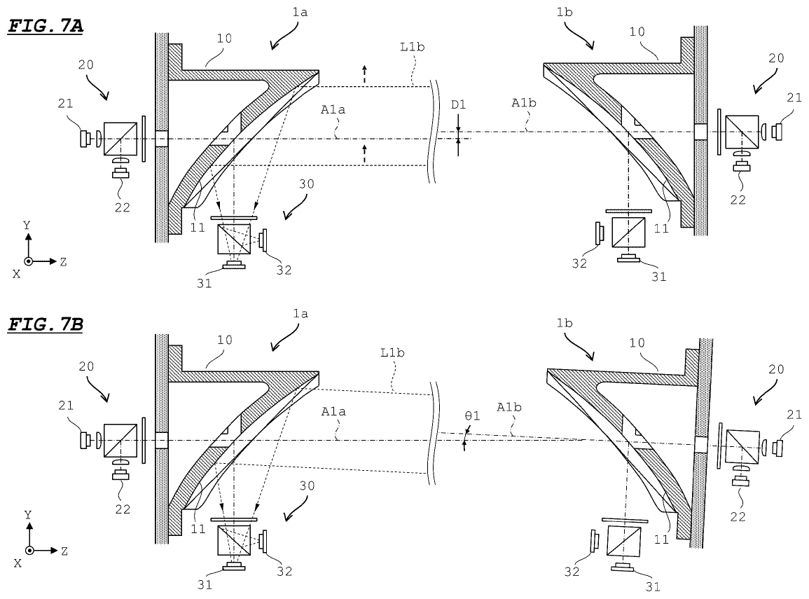

FIG. 7A schematically shows a state where optical axis misalignment occurs between the signal transmitting/receiving devices 1a and 1b.

Here, an optical axis A1b of the signal transmitting/receiving device 1b is misaligned in the Y-axis positive direction by a deviation D1 with respect to an optical axis A1a of the signal transmitting/receiving device 1a. Due to this misalignment, the reception light L1b from the signal transmitting/receiving device 1b is displaced in the Y-axis positive direction as compared to that when there is no misalignment. However, in this case as well, since the light source part 20 (light sources 21 and 22) of the signal transmitting/receiving device 1b, which is a light emitting source, is near the second focal position FP2 in FIG. 6, the reception light L1b emitted from this light emitting source is properly condensed on the photodetectors 31 and 32 of the signal transmitting/receiving device 1a by the reflection surface 11 of the signal transmitting/receiving device 1a. Therefore, a greater amount of the reception light L1b can be guided to each of the photodetectors 31 and 32 of the signal transmitting/receiving device 1a.

FIG. 7B schematically shows a state where the optical axes of the signal transmitting/receiving devices 1a and 1b are tilted with respect to each other by a predetermined angle.

Here, the optical axis A1b of the signal transmitting/receiving device 1b is tilted in a direction parallel to the Y-Z plane by an angle θ1 with respect to the optical axis A1a of the signal transmitting/receiving device 1a. Due to this tilt, the reception light L1b from the signal transmitting/receiving device 1b is tilted in the direction parallel to the Y-Z plane as compared to that when there is no such tilt. However, in this case as well, since the light source part 20 (light sources 21 and 22) of the signal transmitting/receiving device 1b, which is a light emitting source, is near the second focal position FP2 in FIG. 6, the reception light L1b emitted from this light emitting source is properly condensed on the photodetectors 31 and 32 of the signal transmitting/receiving device 1a by the reflection surface 11 of the signal transmitting/receiving device 1a. Therefore, a greater amount of the reception light L1b can be guided to each of the photodetectors 31 and 32 of the signal transmitting/receiving device 1a.

### Effects of Embodiment 1

As shown in FIG. 3, the optical axis A1 of the light source part 20 and the optical axis A2 of the condenser mirror 10 are aligned with each other by the through hole 12, so that position adjustment can be performed simply and smoothly with respect to the other signal transmitting/receiving device 1b. In addition, as described with reference to FIG. 6, the reflection surface 11 of the condenser mirror 10 has a shape obtained by cutting out the columnar body P0 extending in the emission direction of the transmission light L1a, with a spheroid whose rotation axis is the major axis AX1. Therefore, as described with reference to FIG. 7A or FIG. 7B, even if slight optical axis misalignment or optical axis tilt occurs with respect to the other signal transmitting/receiving device 1b, the reception light L1b from the other signal transmitting/receiving device 1b can be guided with sufficient intensity to the photodetectors 31 and 32 of the signal transmitting/receiving device 1a. Accordingly, the quality of signals during transmission and reception can be improved, so that optical communication can be performed with high accuracy.

As shown in FIG. 1, the columnar portion 13 has a quadrangular prism shape. That is, the columnar body P0 cut out with the spheroid in FIG. 6 is a quadrangular prism. Therefore, the area of the reflection surface 11 can be increased as compared to that in the case where the columnar body P0 is a cylinder. That is, in the present embodiment, an area S0 of the reflection surface 11 when viewed from the Z-axis positive side is substantially equal to a value obtained by multiplying the width in the Y-axis direction and the width in the X-axis direction of the columnar portion 13 by each other. Here, since the cross-section of the quadrangular prism when viewed from the Z-axis positive side is substantially a square, when the width in the X-axis direction of the columnar portion 13 is denoted by D, the area S0 is D². On the other hand, in the case where the columnar body P0 is a cylinder having a diameter D, an area S1 of the reflection surface 11 when viewed from the Z-axis positive side is πD²/4. The area S0 is 127% of the area S1. Therefore, by making the columnar portion 13 have a quadrangular prism shape as in the present embodiment, the reception light L1b can be more efficiently condensed on the photodetectors 31 and 32, so that the accuracy of communication can be improved.

As shown in FIG. 2A, FIG. 2B, and FIG. 3, the through hole 12 has the cutout 17 in the inner surface facing the light-receiving part 30. Accordingly, the transmission light L1a scattered at the exit of the through hole 12 can be inhibited from becoming stray light and travelling toward the light-receiving part 30. Therefore, noise due to stray light can be inhibited from being superimposed on the detection signals of the photodetectors 31 and 32, so that the accuracy of communication can be improved.

As shown in FIG. 3, the light source part 20 includes the light sources 21 and 22 and the combining element 25 which aligns the optical axes of the transmission lights L1a emitted from the light sources 21 and 22, respectively, and the light-receiving part 30 includes the photodetectors 31 and 32 and the splitting element 33 which splits the two types of reception light L1b condensed by the condenser mirror 10 and guides the two types of reception light L1b to the photodetectors 31 and 32, respectively. Accordingly, signals can be transmitted and received with two channels using the light sources 21 and 22 and the photodetectors 31 and 32. Therefore, the amount of information that can be transmitted and received can be increased.

As described above, each of the light sources 21 and 22 emits linearly polarized light as the transmission light L1a, and the combining element 25 and the splitting element 33 are polarization beam splitters. Accordingly, by adjusting the polarization direction with respect to the combining element 25, the optical axes of the light sources 21 and 22 can be aligned by the combining element 25, and the two types of reception light L1b having different polarization directions can be split and guided to the photodetectors 31 and 32, respectively, by the splitting element 33.

As shown in FIG. 3, the light source part 20 includes the light sources 21 and 22 each of which emits the linearly polarized transmission light L1a, and the wave plate 26 through which the transmission light L1a emitted from the light sources 21 and 22 passes. Accordingly, each of the linearly polarized transmission lights L1a emitted from the light sources 21 and 22 is converted into circularly polarized light by the wave plate 26. Therefore, when a signal level is changed due to disturbance light, the reception intensity changes at the photodetectors 31 and 32 can be made uniform, so that signal components caused by the disturbance light can be easily separated.

### Embodiment 2

In Embodiment 1 described above, one condenser mirror 10 is placed in one signal transmitting/receiving device 1. On the other hand, in Embodiment 2, a plurality of condenser mirrors 10 are placed in one signal transmitting/receiving device 1.

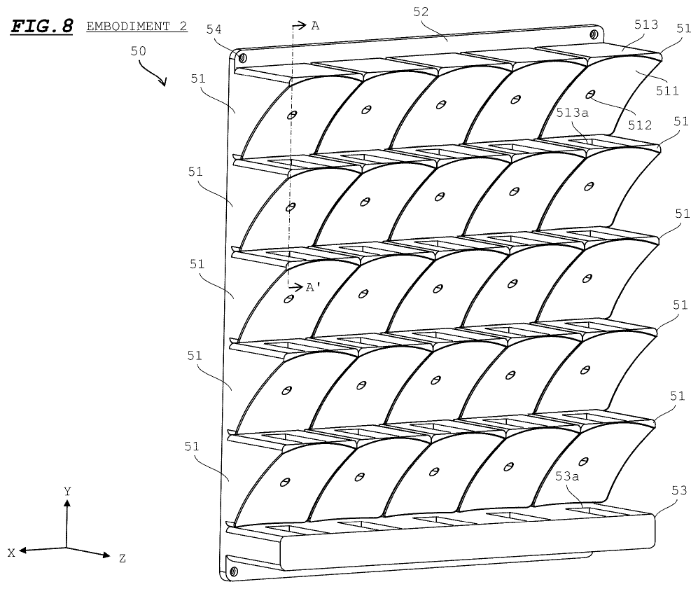

FIG. 8 is a perspective view of a configuration of a mirror unit 50 according to Embodiment 2.

As shown in FIG. 8, the mirror unit 50 includes a plurality of condenser mirrors 51, a back plate portion 52, and a base portion 53. The plurality of condenser mirrors 51, the back plate portion 52, and the base portion 53 are integrally formed from a metal material such as aluminum to configure the mirror unit 50. The mirror unit 50 may be formed from a resin material.

In the configuration in FIG. 8, 25 condenser mirrors 51 are placed in a matrix of 5 rows and 5 columns. The condenser mirrors 51 in the second to fifth rows from the top have the same structure as each other. The condenser mirrors 51 in the first row from the top have the same structure as the condenser mirrors 51 in the second to fifth rows from the top, except that no recess 513a is formed. The back plate portion 52 has a constant thickness. The shape of the back plate portion 52 when viewed from the Z-axis positive side is a rectangular shape that is slightly long in the Y-axis direction and has rounded corners. A fastening hole 54 is formed at each of the four corners of the back plate portion 52 so as to penetrate the back plate portion 52 in the Z-axis direction.

The base portion 53 projects in the Z-axis direction from a position directly below the condenser mirrors 51 in the fifth row by the same projection amount as that of each columnar portion 513. The upper surface of the base portion 53 is parallel to the X-Z plane. On the upper surface of the base portion 53, recesses 53a are formed at positions directly below the exits of through holes 512 of the condenser mirrors 51 in the fifth row. The shape and the size of each recess 53a are the same as those of each recess 513a.

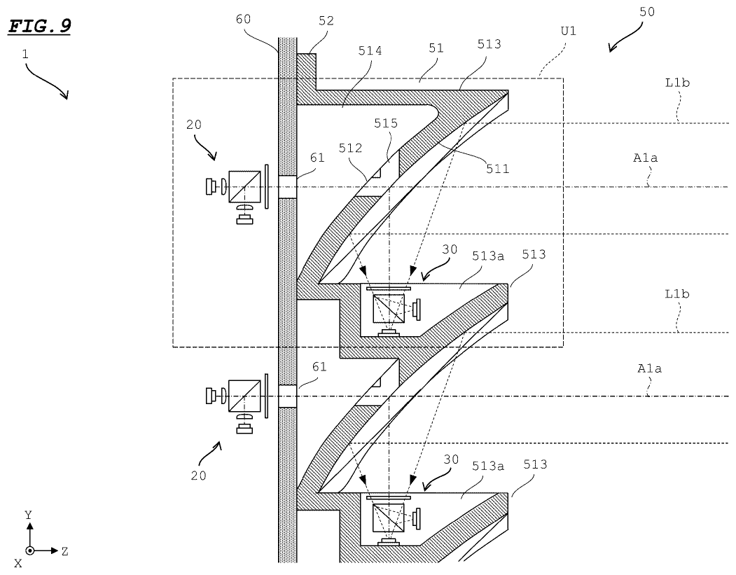

FIG. 9 is a partial side view showing a configuration of the signal transmitting/receiving device 1 according to Embodiment 2.

FIG. 9 shows a state where the light source part 20 and the light-receiving part 30 are placed in the mirror unit 50. In FIG. 9, the mirror unit 50 and a support member 60 are shown in a cross-sectional view taken along a plane parallel to the Y-Z plane at a position A-A′ in FIG. 8.

As shown in FIG. 9, each condenser mirror 51 has a reflection surface 511, a through hole 512, a columnar portion 513, an opening 514, and a cutout 515. As in Embodiment 1 described above, each reflection surface 511 has a shape obtained by cutting out a quadrangular prism with a spheroid. The shapes of the respective reflection surfaces 511 are the same as each other. The centers of the 25 reflection surfaces 511 are contained in the same plane parallel to the X-Y plane. Similar to the through hole 12 in Embodiment 1 described above, the through hole 512 is for allowing the transmission light L1a to pass therethrough. Similar to the cutout 17 in Embodiment 1 described above, the cutout 515 is for suppressing the influence of stray light on the light-receiving part 30.

The mirror unit 50 is installed on the support member 60 by fastening screws to the support member 60 through the fastening holes 54 (see FIG. 8). The support member 60 is a plate-shaped member having a constant thickness. A passage hole 61 is provided in the support member 60 at a position corresponding to the through hole 512 of each condenser mirror 51. As in Embodiment 1 described above, each through hole 512 and each passage hole 61 are coaxial with each other. The support member 60 is supported by an adjustment mechanism (not shown) that can adjust the positions in the X, Y, and Z directions, the tilt in a direction parallel to the Y-Z plane, and the tilt in a direction parallel to the X-Z plane of the adjustment mechanism.

Twenty-five light source parts 20 are installed on the back surface of the support member 60. Each light source part 20 is placed at a position corresponding to the passage hole 61. The configurations of the light source parts 20 are the same as in Embodiment 1 described above. The optical axis A1a of each light source part 20 is aligned with the central axes of the corresponding passage hole 61 and through hole 512. When the position and the tilt of the support member 60 are adjusted by the above-described adjustment mechanism, the position and the tilt of each light source part 20 installed on the support member 60 are adjusted as well.

Light-receiving parts 30 are placed directly below the reflection surfaces 511 of the 25 condenser mirrors 51, respectively. The configuration of each light-receiving part 30 is the same as in Embodiment 1 described above. Recesses 513a are formed on the upper surfaces of the columnar portions 513 of the condenser mirrors 51 in the second to fifth rows. In addition, as shown in FIG. 8, on the upper surface of the base portion 53, a recess 53a is formed at a position directly below each condenser mirror 51 in the fifth row. The light-receiving parts 30 for receiving the reception light L1b condensed by the condenser mirrors 51 in the first to fourth rows are installed in the recesses 513a. In addition, the light-receiving parts 30 for receiving the reception light L1b condensed by the condenser mirrors 51 in the fifth row are installed in the recesses 53a. When the position and the tilt of the support member 60 are adjusted by the above-described adjustment mechanism, the position and the tilt of each light-receiving part 30 are adjusted as well together with the mirror unit 50 installed on the support member 60.

In Embodiment 2, a transmitting/receiving unit U1 is composed of one set of a light source part 20, a light-receiving part 30, and a condenser mirror 51. In the configuration in FIG. 8 and FIG. 9, 25 transmitting/receiving units U1 are placed in a matrix of 5 rows and 5 columns. Each transmitting/receiving unit U1 transmits and receives signals to and from each transmitting/receiving unit U1 of another signal transmitting/receiving device 1b having the same configuration as in FIG. 9. A method for placing two transmitting/receiving units U1 that transmit and receive signals to and from each other is the same as the method for placing the signal transmitting/receiving devices 1a and 1b shown in FIG. 4 in Embodiment 1 described above.

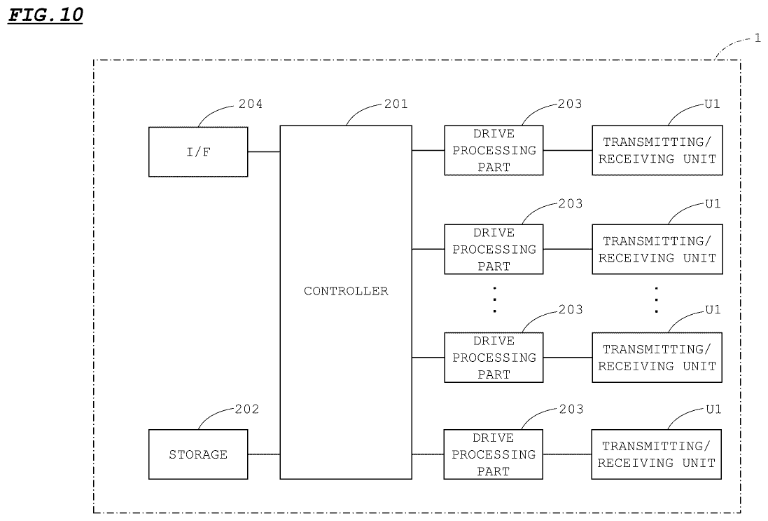

FIG. 10 is a block diagram showing a configuration of a circuitry of the signal transmitting/receiving device 1 according to Embodiment 2.

The signal transmitting/receiving device 1 includes a controller 201, a storage 202, 25 drive processing parts 203, and an interface 204. The 25 drive processing parts 203 are connected to the 25 transmitting/receiving units U1, respectively. Each drive processing part 203 includes the same circuitry as the drive parts 103 and 104 and the processing parts 105 and 106 in FIG. 5. The drive processing part 203 drives the light sources 21 and 22 of the transmitting/receiving unit U1 under control from the controller 201, processes signals from the photodetectors 31 and 32 of the transmitting/receiving unit U1, and outputs the processed signals to the controller 101.

The controller 201 receives transmission data of two channels to be transmitted by each transmitting/receiving unit U1, from a higher-order system via the interface 204. As in Embodiment 1 described above, the controller 201 generates AM-modulated transmission signals of the two channels from the received transmission data of the two channels, and outputs the generated transmission signals to the corresponding drive processing part 203. The drive processing part 203 drives the light sources 21 and 22 of the transmitting/receiving unit U1 by the received transmission signals of the two channels, respectively. Accordingly, transmission light L1a of each channel is transmitted to the corresponding transmitting/receiving unit U1 of the other signal transmitting/receiving device 1b.

When a transmitting/receiving unit U1 receives reception light L1b from the corresponding transmitting/receiving unit U1 of the other signal transmitting/receiving device 1b, detection signals of the respective channels are outputted from the photodetectors 31 and 32 of the transmitting/receiving unit U1 to the drive processing part 203. The drive processing part 203 processes the inputted detection signal of each channel in the same manner as the processing part 105 in Embodiment 1 described above, and outputs the processed detection signal to the controller 201. The controller 201 demodulates the inputted detection signal of each channel to generate reception data, and outputs the generated reception data to the higher-order system via the interface 107.

In this manner, the transmission signals of the two channels are transmitted and received by each transmitting/receiving unit U1. In the present embodiment, since the 25 transmitting/receiving units U1 are placed in the signal transmitting/receiving device 1, transmission signals of 50 channels can be transmitted and received in total. Thus, with the configuration of Embodiment 2, transmission and reception of a huge amount of transmission data can be realized.

However, in the case where a plurality of condenser mirrors 51 are placed adjacent to each other in a matrix as shown in FIG. 8, if the mirror unit 50 is misaligned or tilted, the transmission light L1a transmitted from one transmitting/receiving unit U1 may be received not only by the corresponding transmitting/receiving unit U1 of the other signal transmitting/receiving device 1b but also by a transmitting/receiving unit U1 adjacent thereto. In this case, on the detection signals outputted from the photodetectors 31 and 32 of the transmitting/receiving unit U1, signal components due to other transmission light L1a are superimposed in addition to signal components due to the transmission light L1a from the reception target. Therefore, the accuracy and the quality of the reception data of the channels may decrease.

In order to solve this problem, in Embodiment 2, an adjustment mode for eliminating misalignment and tilt of the mirror unit 50 is executed in each controller 201 of the signal transmitting/receiving devices 1a and 1b prior to actual transmission/reception processing.

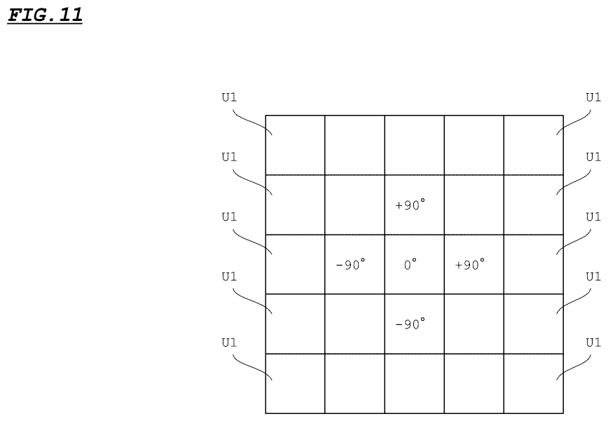

FIG. 11 shows the phases of the transmission light L1a set for the transmitting/receiving units U1 of the signal transmitting/receiving device 1a in the adjustment mode.

Here, the adjustment mode is executed using five transmitting/receiving units U1 around the center out of the 25 transmitting/receiving units U1. The phases of the transmission light L1a for the transmitting/receiving units U1 on the upper and lower sides of the center transmitting/receiving unit U1 (hereinafter, referred to as “standard transmitting/receiving unit U1”) are set to +90° and −90°, respectively. The phases of the transmission light L1a for the transmitting/receiving unit U1 on the left and right sides of the standard transmitting/receiving unit U1 are set to −90° and +90°, respectively.

With the phases set as described above, transmission lights L1a for adjustment are emitted simultaneously from the standard transmitting/receiving unit U1 and one of the transmitting/receiving units U1 on the upper, lower, left, and right sides thereof. This emission is performed using one of the light sources 21 and 22 placed in the corresponding transmitting/receiving unit U1. In the adjustment mode, a signal that has a single amplitude and a single cycle and is not AM-modulated is used as a drive signal for this light source. This signal is generated, for example, using a local oscillator.

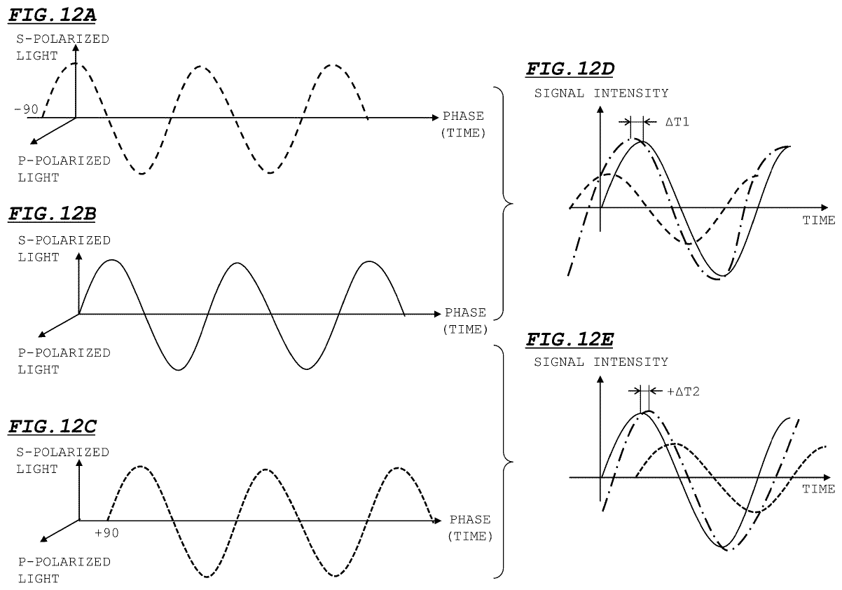

FIG. 12A to FIG. 12C each schematically show the intensity change of the transmission light L1a transmitted toward the other signal transmitting/receiving device 1b when the adjustment mode is executed.

In the example in FIG. 12A to FIG. 12C, the transmission light L1a that is S-polarized with respect to the splitting element 33 of the other signal transmitting/receiving device 1b, that is, the transmission light L1a emitted from the light source 22 of the one signal transmitting/receiving device 1a, is used for the adjustment mode.

FIG. 12B shows the intensity change of the transmission light L1a emitted from the standard transmitting/receiving unit U1 of the one signal transmitting/receiving device 1a, and FIG. 12A and FIG. 12C show the intensity changes of the transmission lights L1a emitted from the transmitting/receiving units U1 adjacent to the standard transmitting/receiving unit U1 on the left (or lower) and right (or upper) sides, respectively. The transmission light L1a in FIG. 12A is shifted in phase by −90° with respect to the transmission light L1a in FIG. 12B, and the transmission light L1a in FIG. 12C is shifted in phase by +90° with respect to the transmission light L1a in FIG. 12B.

FIG. 12D and FIG. 12E each schematically show the intensity change of the detection signal outputted from the photodetector 31 of the transmitting/receiving unit U1 at the center of the other signal transmitting/receiving device 1b when the adjustment mode is executed.

FIG. 12D shows the intensity change of the detection signal when the transmission lights in FIG. 12A and FIG. 12B are emitted simultaneously, and FIG. 12E shows the intensity change of the detection signal when the transmission lights in FIG. 12B and FIG. 12C are emitted simultaneously.

In each of FIG. 12D and FIG. 12E, a solid line shows the detection signal when the transmitting/receiving unit U1 at the center of the other signal transmitting/receiving device 1b (hereinafter, referred to as “reference transmitting/receiving unit U1”) receives only the transmission light L1a in FIG. 12B (the transmission light L1a from the standard transmitting/receiving unit U1).

In FIG. 12D, a broken line shows a detection signal by the transmission light L1a in FIG. 12A (the transmission light L1a of the transmitting/receiving unit U1 located to the left of (or below) the standard transmitting/receiving unit U1) when this transmission light L1a interferes with the reference transmitting/receiving unit U1. In FIG. 12D, an alternate long and short dash line shows a detection signal obtained by combining the detection signal shown by the solid line and the detection signal shown by the broken line. In FIG. 12E, a dotted line shows a detection signal by the transmission light L1a in FIG. 12C (the transmission light L1a of the transmitting/receiving unit U1 located to the right of (or above) the standard transmitting/receiving unit U1) when this transmission light L1a interferes with the reference transmitting/receiving unit U1. In FIG. 12E, an alternate long and short dash line shows a detection signal obtained by combining the detection signal shown by the solid line and the detection signal shown by the dotted line.

When the transmission light in FIG. 12A interferes with the transmission light in FIG. 12B in the reference transmitting/receiving unit U1, the detection signal shown by the alternate long and short dash line in FIG. 12D is outputted from the photodetector 31 of the reference transmitting/receiving unit U1. In this case, the detection signal is delayed in phase by ΔT1 with respect to the detection signal shown by the solid line when there is no interference. The phase shift amount ΔT1 becomes greater as a greater amount of the transmission light in FIG. 12A interferes.

When the transmission light in FIG. 12C interferes with the transmission light in FIG. 12B in the reference transmitting/receiving unit U1, the detection signal shown by the alternate long and short dash line in FIG. 12E is outputted from the photodetector 31 of the reference transmitting/receiving unit U1. In this case, the detection signal advances in phase by ΔT2 with respect to the detection signal shown by the solid line when there is no interference. The phase shift amount ΔT2 becomes greater as a greater amount of the transmission light in FIG. 12C interferes.

Thus, by referring to the phase shift between the detection signal outputted from the reference transmitting/receiving unit U1 when there is no interference (hereinafter, referred to as “reference detection signal”) and the detection signal actually obtained, it can be determined whether or not the transmission light L1a emitted from the transmitting/receiving unit U1 adjacent to the standard transmitting/receiving unit U1 of the one signal transmitting/receiving device 1a has interfered with the reference transmitting/receiving unit U1.

Here, the reference detection signal can be generated by a local oscillator installed in the other signal transmitting/receiving device 1b. In this case, at a preparatory stage of adjustment mode execution, the local oscillator on the one signal transmitting/receiving device 1a side and the local oscillator on the other signal transmitting/receiving device 1b are synchronized with each other.

For the synchronization, for example, transmission light L1a corresponding to a signal of the local oscillator on the signal transmitting/receiving device 1a side is emitted from only the standard transmitting/receiving unit U1 of the one signal transmitting/receiving device 1a. In parallel, the reference transmitting/receiving unit U1 of the other signal transmitting/receiving device 1b and the transmitting/receiving units U1 around the reference transmitting/receiving unit U1 perform reception processing of the transmission light L1a. The phase of the local oscillator on the other signal transmitting/receiving device 1b side is adjusted so as to match the phase of the detection signal obtained by this reception processing. Accordingly, a signal outputted from the local oscillator on the one signal transmitting/receiving device 1a side and a signal outputted from the local oscillator on the other signal transmitting/receiving device 1b side are synchronized with each other.

The misalignment and the tilt of the mirror unit 50 may be corrected by an operator who installs the signal transmitting/receiving devices 1a and 1b. In this case, the operator performs operation input for executing the above synchronization, on the signal transmitting/receiving devices 1a and 1b via operation terminals connected to the signal transmitting/receiving devices 1a and 1b, respectively. Accordingly, each controller 201 of the signal transmitting/receiving devices 1a and 1b executes control for the above synchronization.

Then, when the synchronization is completed, the operator performs operation input for executing the adjustment mode, on the signal transmitting/receiving devices 1a and 1b via the operation terminals. Accordingly, the controller 201 of the one signal transmitting/receiving device 1a sets a pair of the standard transmitting/receiving unit U1 and the transmitting/receiving unit U1 on the upper side thereof, a pair of the standard transmitting/receiving unit U1 and the transmitting/receiving unit U1 on the lower side thereof, a pair of the standard transmitting/receiving unit U1 and the transmitting/receiving unit U1 on the right side thereof, and a pair of the standard transmitting/receiving unit U1 and the transmitting/receiving unit U1 on the left side thereof, as pairs of transmission targets, and simultaneously emits transmission lights L1a based on the signal of the local oscillator from each pair of transmission targets in this order.

For each pair of transmission targets, the controller 201 of the other signal transmitting/receiving device 1b calculates the phase shift between the detection signal outputted from the reference transmitting/receiving unit U1 and the signal from the local oscillator of the other signal transmitting/receiving device 1b. Then, the controller 201 of the other signal transmitting/receiving device 1b displays the phase shift calculated for each pair, on the operation terminal connected to the other signal transmitting/receiving device 1b. The operator determines the magnitudes and the directions of the misalignment and the tilt of the mirror unit 50 of the signal transmitting/receiving device 1a on the basis of the displayed phase for each pair. Then, the operator operates the adjustment mechanism to change the position and the tilt of the mirror unit 50 such that the misalignment and the tilt determined by the operator are corrected.

The operator repeats the above operation a plurality of times to change the position and the tilt of the mirror unit 50 of the one signal transmitting/receiving device 1a such that the phase shift calculated for each pair gradually becomes smaller. Furthermore, the operator switches the other signal transmitting/receiving device 1b to the transmission side and the one signal transmitting/receiving device 1a to the reception side as appropriate, and performs the same operations as above. In this manner, the operator adjusts the mirror unit 50 of the signal transmitting/receiving devices 1a and 1b to the position and the tilt where the phase shift calculated for each pair is minimized. Accordingly, the operator finishes the adjustment operation for the mirror unit 50 using the adjustment mode.

Although the operator performs the adjustment operation for the mirror unit 50 using the adjustment mode, this adjustment may be performed automatically by a control device or the controllers 201 of the signal transmitting/receiving devices 1a and 1b.

When the control device automatically performs this adjustment, the control device is connected to the signal transmitting/receiving devices 1a and 1b. In this case, the adjustment mechanism for the mirror unit 50 includes a drive source such as a motor, and is driven in accordance with control from the control device. The control device has a control algorithm for changing the position and the tilt of the mirror unit 50 on the basis of the phase shift calculated for each pair. The control device performs the same control as the above operator according to this algorithm.

When the controllers 201 of the signal transmitting/receiving devices 1a and 1b automatically perform the above adjustment, the signal transmitting/receiving devices 1a and 1b are connected to each other by a communication line. In this case as well, the adjustment mechanism for the mirror unit 50 includes a drive source such as a motor, and is driven in accordance with control from each controller 201. Each controller 201 has a control algorithm for changing the position and the tilt of the mirror unit 50 on the basis of the phase shift calculated for each pair. Each controller 201 performs the same control as the above operator according to this algorithm.

### Effects of Embodiment 2

As shown in FIG. 8 and FIG. 9, the plurality of transmitting/receiving units U1 each having the light source part 20, the light-receiving part 30, and the condenser mirror 51 are placed. Accordingly, the amount of information that can be simultaneously transmitted and received can be increased, so that large-volume data communication can be smoothly executed.

As shown in FIG. 8 and FIG. 9, the plurality of transmitting/receiving units U1 are placed in a matrix on the same plane. Accordingly, the plurality of transmitting/receiving units U1 can be accommodated in a compact space, so that the size of the signal transmitting/receiving device 1 can be reduced.

As shown in FIG. 10, the signal transmitting/receiving device 1 includes the controller 201 which controls the light source part 20, and the controller 201 has the adjustment mode in which the phases of the transmission lights emitted from the adjacent light source parts 20 are shifted from each other and the transmission light is emitted from each light source part 20. Accordingly, as described above, it can be determined that one transmitting/receiving unit U1 is being interfered with by another transmitting/receiving unit U1, and the position and the tilt of the mirror unit 50 can be corrected such that this interference is suppressed.

The phase set for each transmitting/receiving unit U1 in the adjustment mode is not limited to the phase illustrated in FIG. 11. As long as the phase shift between the adjacent transmitting/receiving units U1 is within 180° (π/2),other phases may be set for the transmitting/receiving units U1. In addition, the transmitting/receiving units U1 used for the adjustment mode are not limited to the transmitting/receiving units U1 shown above, but can be changed as appropriate as long as it is possible to determine and suppress interference.

### Modifications

In Embodiments 1 and 2 described above, the two light sources 21 and 22 are placed in each light source part 20, but the number of light sources placed in each light source part 20 is not limited thereto. For example, only one light source 21 may be placed in each light source part 20. In this case, the combining element 25 is omitted from each light source part 20, and the photodetector 32, the splitting element 33, and the wave plate 34 are omitted from each light-receiving part 30.

In Embodiments 1 and 2 described above, the combining element 25 is composed of a polarization beam splitter. However, the combining element 25 may be composed of a dichroic mirror. In this case, the wavelengths of the light sources 21 and 22 are set to a wavelength that allows passing through the dichroic mirror and a wavelength that allows reflection by the dichroic mirror, respectively. In addition, the splitting element 33 of the light-receiving part 30 is composed of a dichroic mirror that allows light having the wavelength of the light source 21 to pass therethrough and that reflects light having the wavelength of the light source 22.

In this case, a plurality of dichroic mirrors may be placed in the light source part 20, and transmission lights L1a from three or more light sources may be combined. For example, transmission lights from first and second laser light sources having different wavelengths may be combined by a first dichroic mirror, and the combined two transmission lights and transmission light from a third laser light source having a wavelength different from those of these two transmission lights may be combined by a second dichroic mirror. In this case, the two dichroic mirrors for splitting the transmission lights having these three wavelengths are placed in the light-receiving part 30.

In addition, the combination of the transmission lights L1a and the split of the reception lights L1b may be performed by other optical elements such as a diffraction grating.

The wave plates 26 and 34 may be omitted from the configuration in FIG. 3. In this case, the transmission lights L1a from the light sources 21 and 22 are transmitted as linearly polarized lights to the other signal transmitting/receiving device 1b, and are split by the splitting element 33 (polarization beam splitter) of the other signal transmitting/receiving device 1b.

In the configuration in FIG. 3, the wave plate 26 does not have to be a quarter-wave plate, and may be a wave plate that converts each of the linearly polarized transmission lights L1a emitted from the light sources 21 and 22, into elliptically polarized light. In this case, the wave plate 34 of the light-receiving part 30 is replaced by a wave plate that converts these two types of elliptically polarized lights into linearly polarized lights that are S-polarized and P-polarized with respect to the splitting element 33, respectively. Due to this as well, the same effects as those of the wave plate 26 in Embodiment 1 described above can be achieved.

In Embodiments 1 and 2 described above, the reflection surfaces 11 and 511 of the condenser mirrors 10 and 51 each have a shape obtained by cutting out a columnar body, which is a quadrangular prism, with a spheroid. However, the columnar body cut out with the spheroid is not limited to the quadrangular prism, and, for example, the reflection surfaces 11 and 511 of the condenser mirrors 10 and 51 may each have a shape by cutting out a columnar body, which is a cylinder, with a spheroid.

In Embodiments 1 and 2 described above, the cutouts 17 and 515 are formed so as to extend in the Y-axis positive direction, but the method for forming the cutouts 17 and 515 is not limited thereto. Each of the cutouts 17 and 515 only has to be formed such that light scattered near the exit of the through hole 12 or 512 can be inhibited from travelling toward the light-receiving part 30.

In each of Embodiments 1 and 2 described above, by forming the cutout 17 or 515 at the through hole 12 or 512, the transmission light L1a scattered at the exits of the through hole 12 or 512 is inhibited from being incident on the photodetectors 31 and 32. Instead of this configuration, a light blocking mask for blocking the transmission light L1a scattered at the exit of the through hole 12 or 512 may be placed between the exit of the through hole 12 or 512 and the light-receiving part 30.

The structure of the mirror unit 50 shown in Embodiment 2 described above is not necessarily limited to the structure shown in FIG. 8 and FIG. 9, and may be changed as appropriate. For example, in the structure in FIG. 8, the recesses 513a for installing the light-receiving parts 30 are formed on the upper surfaces of the columnar portions 513 of the condenser mirrors 51. However, in the case where the interval between the vertically adjacent condenser mirrors 51 is wider than in FIG. 8, on each of the upper surfaces of the columnar portions 513 of the condenser mirrors 51, the light-receiving part 30 for receiving the reception light L1b from the condenser mirror 51 directly thereabove may be placed without providing a recess 513a.

In Embodiments 1 and 2 described above, the PAM4 method is used as the modulation method for the transmission light L1a emitted from each of the light sources 21 and 22, but the modulation method for the transmission light L1a is not limited thereto. For example, when the modulation method for the transmission light L1a is AM modulation, an NRZ (Non Return to Zero) method may be used.

In the configuration of Embodiment 2, a carrier frequency for AM modulation of the transmitted light L1a may be different between the adjacent transmitting/receiving units U1. Accordingly, even when interference (crosstalk) of the reception light L1b occurs between the adjacent transmitting/receiving units U1, the detection signal of the carrier frequency to be received by each transmitting/receiving unit U1 can be extracted by frequency discrimination, so that the influence of the interference can be suppressed.

The modulation method for the transmission light L1a is not limited to AM modulation, and other modulation methods such as FM modulation may be used.

In addition to the above, various modifications can be made as appropriate to the embodiments of the present invention, without departing from the scope of the technological idea defined by the claims.

Although the above embodiment shows the signal transmitting/receiving system using light, a sensor device for detecting an object can also be realized using the condenser mirror 10 in FIG. 1.

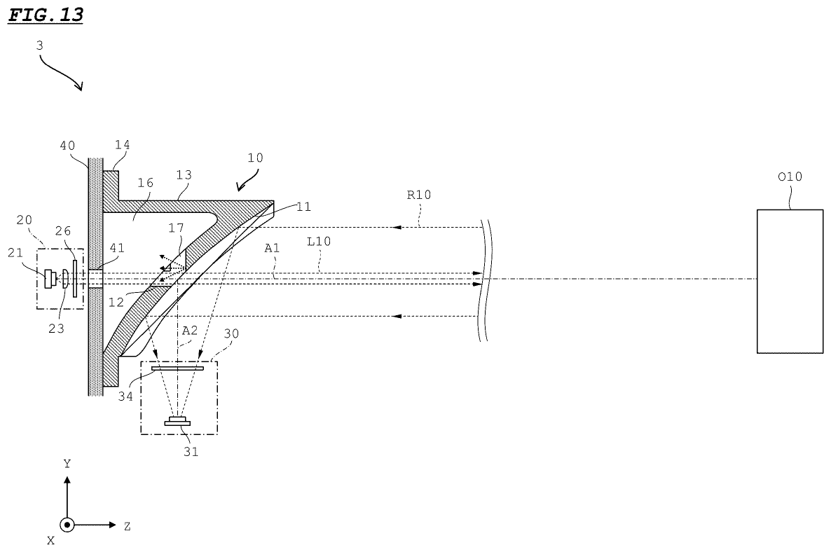

For example, with a configuration shown in FIG. 13, it can be detected whether or not an object O10 exists in a traveling direction of detection light L10 emitted from the light source 21. For convenience, in FIG. 13, the same components as in the signal transmitting/receiving device 1 in FIG. 3 are designated by the same reference characters. A sensor device 3 in FIG. 13 has a configuration in which the light source 22, the collimator lens 24, the combining element 25, the photodetector 32, and the splitting element 33 are omitted from the configuration in FIG. 3.

In the sensor device 3 having this configuration, reflected light R10, of the light L10, from the object O10, is condensed on the photodetector 31 by the reflection surface 11 of the condenser mirror 10. In this case, the light L10 from the light source 21 does not need to be modulated in accordance with transmission data. The light source 21 is, for example, continuously driven with constant intensity or periodically driven in a pulsed manner with constant intensity. In the case of being driven in a pulsed manner, the timing of pulsed light emission is the timing of object detection.

As shown in FIG. 13, the sensor device 3 includes the light source 21 which emits detection light, the photodetector 31 which receives reflected light obtained by reflecting the detection light by an object, and the condenser mirror 10 which condenses the reflected light on the photodetector 31. Here, the condenser mirror 10 has the through hole 12 which allows the detection light emitted from the light source 21 to pass therethrough and aligns the optical axis of the light source 21 and the optical axis of the condenser mirror 10 with each other. The reflection surface 11 of the condenser mirror 10 has a shape obtained by cutting out a columnar body extending in an emission direction of the detection light, with a spheroid whose rotation axis is a major axis.

In this sensor device 3 as well, as in FIG. 6, the reflection surface 11 of the condenser mirror 10 has a shape obtained by cutting out the columnar body P0 extending in the emission direction of the light L10, with a spheroid whose rotation axis is the major axis AX1. Therefore, even if the optical axis A1 is tilted, the reflected light R10 from the object O10 can be guided with sufficient intensity to the photodetector 31. In addition, even if the reflected light R10 becomes scattered light due to the surface condition of the object O10 or even if the object O10 is placed so as to be tilted with respect to the optical axis, the reflected light R10 can be guided with sufficient intensity to the photodetector 31. Accordingly, the accuracy of object detection can be increased.

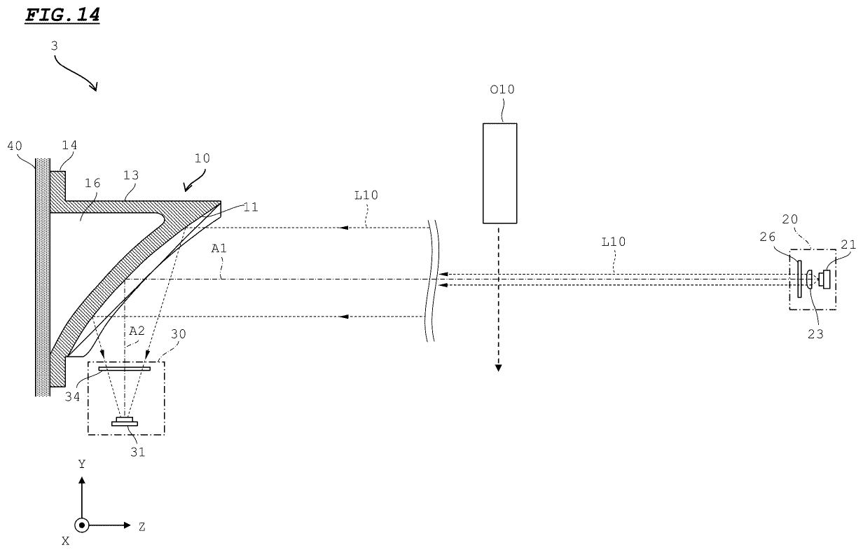

The sensor device 3 can also be configured as shown in FIG. 14. In this configuration, the light source part 20 and the condenser mirror 10 are placed so as to face each other in the Z-axis direction. The positions of the light source part 20 and the condenser mirror 10 are adjusted such that the optical axis A1 of the light source part 20 and the optical axis A2 of the condenser mirror 10 are aligned with each other. Since the light source part 20 is placed so as to face the condenser mirror 10, there is no need to provide a through hole 17 in the condenser mirror 10 as shown in FIG. 13. Therefore, in the configuration in FIG. 14, the through hole 17 is omitted, and the reflection surface 11 becomes a uniform curved surface having no hole.

In this configuration, when the object O10 crosses an optical axis L10, the detection light L10 is blocked, and is not received by the photodetector 31. Therefore, the object O10 is detected by the output of the photodetector 31.

As shown in FIG. 14, the sensor device 3 includes the light source 21 which emits detection light, the photodetector 31 which receives the detection light, and the condenser mirror 10 which is placed facing the light source 21 and condenses the detection light on the photodetector 31. Here, the reflection surface 11 of the condenser mirror 10 has a shape obtained by cutting out a columnar body extending in a direction opposite to an emission direction of the detection light, with a spheroid whose rotation axis is a major axis.

In this sensor device 3 as well, as in FIG. 6, the reflection surface 11 of the condenser mirror 10 has a shape obtained by cutting out the columnar body P0 extending in the direction opposite to the emission direction of the light L10, with a spheroid whose rotation axis is the major axis AX1. Even if slight optical axis misalignment or tilt occurs between the condenser mirror 10 and the light source part 20, the detection light L10 from the light source part 20 can be guided with sufficient intensity to the photodetector 31. Accordingly, the accuracy of object detection can be increased.

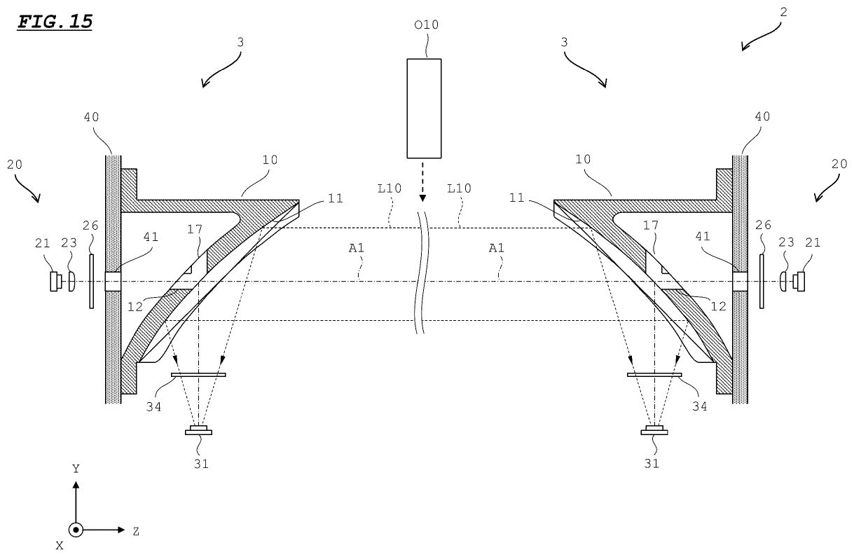

As shown in FIG. 15, sensor devices 3 as shown in FIG. 13 may be placed facing each other in the Z-axis direction. In this case, while the light source 21 of one sensor device 3 is caused to emit light, the photodetector 31 of the other sensor device 3 detects the detection light L10. Accordingly, it can be detected that the object O10 has crossed the optical axis A1. In the configurations in FIG. 13 to FIG. 15, the wave plates 26 and 34 may be omitted.

What is claimed is:

1. A signal transmitting/receiving device comprising:
a light source part configured to emit transmission light;
a light-receiving part having a photodetector configured to receive reception light; and
a condenser mirror configured to condense the reception light on the photodetector, wherein
the condenser mirror has a through hole configured to allow the transmission light emitted from the light source part to pass therethrough and align an optical axis of the light source part and an optical axis of the condenser mirror with each other, and
a reflection surface of the condenser mirror has a shape obtained by cutting out a columnar body extending in an emission direction of the transmission light, with a spheroid whose rotation axis is a major axis.

2. The signal transmitting/receiving device according to claim 1, wherein the columnar body is a quadrangular prism.

3. The signal transmitting/receiving device according to claim 1, wherein the through hole has a cutout in an inner surface facing the light-receiving part.

4. The signal transmitting/receiving device according to claim 1, wherein
the light source part includes
a first light source,
a second light source, and
a combining element configured to align optical axes of the transmission lights emitted from the first light source and the second light source, respectively, and
the light-receiving part includes
a first photodetector,
a second photodetector, and
a splitting element configured to split two types of the reception light condensed by the condenser mirror and guide the two types of the reception light to the first photodetector and the second photodetector, respectively.

5. The signal transmitting/receiving device according to claim 4, wherein
the first light source and the second light source each emit linearly polarized light as the transmission light, and
the combining element and the splitting element are polarization beam splitters.

6. The signal transmitting/receiving device according to claim 1, wherein the light source part includes
a light source configured to emit the transmission light which is linearly polarized light, and
a wave plate through which the transmission light emitted from the light source passes.

7. The signal transmitting/receiving device according to claim 1, wherein a plurality of transmitting/receiving units each having the light source part, the light-receiving part, and the condenser mirror are placed.

8. The signal transmitting/receiving device according to claim 7, wherein the plurality of transmitting/receiving units are placed in a matrix on the same plane.

9. The signal transmitting/receiving device according to claim 7, further comprising a controller configured to control the light source parts, wherein
the controller has an adjustment mode in which phases of the transmission lights emitted from the adjacent light source parts are shifted from each other and the transmission light is emitted from each light source part.
